(19) United States
(12) Patent Application Publication
(10) Pub. No.: US 2006/0171879 A1
(43) Pub. Date: Aug. 3, 2006

(54) Zero Energy Input Hydrogen/Zinc Sulfate Process

(75) Inventor: Christopher Dale Hunter, Wasilla, AK (US)

Correspondence Address: Mr.Christopher Dale Hunter, 3150 South Storybook Circle, Wasilla, AK, 99654, US

(73) Assignee: Mr. Christopher Dale Hunter, Wasilla, AK (US)

(21) Appl. No.: 10/906,031

(22) Filed: Jan. 31, 2005

(51) Int. Cl. C01G 13/00; C01B 17/96; C01B 6/24

(52) U.S. Cl. 423/644; 423/99; 423/544

(57) ABSTRACT

The production of Hydrogen and/or Zinc Sulfate by the chemical reaction of Sulfuric Acid and Zinc Coated Steel or another Zinc and Metal material. The sulfuric acid and zinc coated metal are brought together in a closed container. The dissimilar metals intensify the reaction—act as a catalyst. The hydrogen will bubble off the reaction and can be captured and purified if needed. When the reaction is spent, the chief by-product is zinc sulfate which can be collected and converted to a form for sale.

The process utilizing the zinc coated metal utilizes the electrolyte solution of sulfuric acid to set up an electric charge and thus the electric charge being set up between two dissimilar metals causes the zinc that is coated to the metal to trade places with the hydrogen molecules of the H2SO4 (sulfuric acid), the hydrogen, being not able to bond with the metal used as a catalyst will bubble off and the zinc which was previously bonded to the metallic catalyst bonds to what was previously H2SO4 and becomes a new chemical ZnSO4 or Zinc Sulfate.

The process is laid out as follows: The sulfuric acid and the appropriate amounts of zinc coated metal are introduced to each other. The metal that the zinc is coated onto is used as a catalyst to set up an electric charge that not only breaks the bonds between the Hydrogen in the sulfuric acid, but also breaks the bonds between the zinc and the metal that it is bonded to, thus the hydrogen and the zinc are allowed to re-structure the bonds freely and thereby producing Zinc-Sulfate and Hydrogen gas. The catalyst is then extracted from the Zinc Sulfate crystals.

What is claimed is:

1. I have found a way to produce hydrogen add zinc sulfate by a chemical reaction which requires no added energy input.

2. This process will produce large amounts of hydrogen.

3. This process also produces zinc sulfate as a byproduct.
